(19) United States
(12) Patent Application Publication
(10) Pub. No.: US 2007/0294584 A1
(43) Pub. Date: Dec. 20, 2007

(54) Detection and isolation of data items causing computer process crashes

(75) Inventors: Chandresh K. Jain, Sammamish, WA (US); Jeffrey C. Stamerjohn, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/413,223

(22) Filed: Apr. 28, 2006

(51) Int. Cl. G06F 11/00

(52) U.S. Cl. 714/37

(57) ABSTRACT

Described herein is technology for, among other things, detecting a data item that causes a process running within a computer system processing multiple data items to crash when the data item is processed. The technology involves associating a unique identifier with each data item prior to the data item being processed. If the processing of a particular data item causes a crash, the particular data item's unique identifier is stored in a persistent storage and the process is restarted in response to the crash. Once the process has restarted, the unique identifier is read from the persistent storage and the data item associated with the unique identifier is flagged as the data item that caused the process to crash.

### BACKGROUND

Server software needs to be highly reliable and have a high uptime. Although these systems are typically designed in a way that generally achieves reliability, there are times that certain items of data (hereinafter referred to as “poison data items”) expose some vulnerability in the software, which causes it to crash and reduces uptime.

For example, an electronic mail server may encounter a message that has a certain property that has not been accounted for in the server software. Because the server does not know how to deal with this property, the result may be a crash of the server. Once the server has restarted, it will attempt to process the same message again, with the same property causing another crash, and so on. In order to break the crash-restart loop, the mail server must be shut down and its queues must be manually examined by the system administrator to determine the cause of the problems.

The process of identifying the poison data item can be very extensive, including collecting a great deal of diagnostic information and analyzing crash dumps to find the exact data item. In some instances, these methods can be unsuccessful, in which case the server software developer's product support group must be contacted so that they can use their own custom tools to remove the poison data item from the system. These procedures potentially mean a significant amount of downtime for a server. In some extreme cases, the user may even decide to decommission the server from the production environment until the root cause of the problem is found and fixed.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Described herein is technology for, among other things, detecting a data item that causes a process running within a computer system processing multiple data items to crash when the data item is processed. The technology involves associating a unique identifier with each data item prior to the data item being processed. If the processing of a particular data item causes a crash, the particular data item's unique identifier is stored in a persistent storage and the process is restarted in response to the crash. Once the process has restarted, the unique identifier is read from the persistent storage and the data item associated with the unique identifier is flagged as the data item that caused the process to crash.

The technology also allows for a crash count to be kept for each data item. If the crash count for a particular data item is greater than a crash threshold value, the technology allows for the data item to be isolated from the process.

Thus, a data item that causes a process running within a computer system to crash can be identified. Once the offending data item has been identified, it can be isolated, thereby preventing a continuous crash-restart loop. Furthermore, the isolation means may be user-configurable to conform to the user's needs, thus alleviating the sometimes expensive and tedious need for manual examination of the system to determine the cause of the crash.

### BRIEF DESCRIPTION OF THE DRAWINGS

The accompanying drawings, which are incorporated in and form a part of this specification, illustrate embodiments of the invention and, together with the description, serve to explain the principles of the claimed subject matter:

FIG. 1 is a block diagram illustrating a system for detecting a data item that causes a process running on a computer system to crash, in accordance with an embodiment.

FIG. 2 is a flowchart illustrating a process of detecting a data item that causes a process running on a computer system to crash, in accordance with an embodiment.

FIG. 3 illustrates an example of a suitable computer system 300 on which embodiments may be implemented.

### DETAILED DESCRIPTION

Reference will now be made in detail to the preferred embodiments of the claimed subject matter, examples of which are illustrated in the accompanying drawings. While the claimed subject matter will be described in conjunction with the preferred embodiments, it will be understood that they are not intended to limit the claimed subject matter to these embodiments. On the contrary, the claimed subject matter is intended to cover alternatives, modifications and equivalents, which may be included within the spirit and scope of the claimed subject matter as defined by the claims. Furthermore, in the detailed description of the claimed subject matter, numerous specific details are set forth in order to provide a thorough understanding of the claimed subject matter. However, it will be obvious to one of ordinary skill in the art that the claimed subject matter may be practiced without these specific details. In other instances, well known methods, procedures, components, and circuits have not been described in detail as not to unnecessarily obscure aspects of the claimed subject matter.

Some portions of the detailed descriptions that follow are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the claimed subject matter.

It should be borne in mind, however, that all of these terms are to be interpreted as referencing physical manipulations and quantities and are merely convenient labels and are to be interpreted further in view of terms commonly used in the art. Unless specifically stated otherwise as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display devices.

Embodiments provide methods and systems for detecting a data item that causes a process running on a computer system to crash when processed (hereinafter also referred to as “poison data items”).

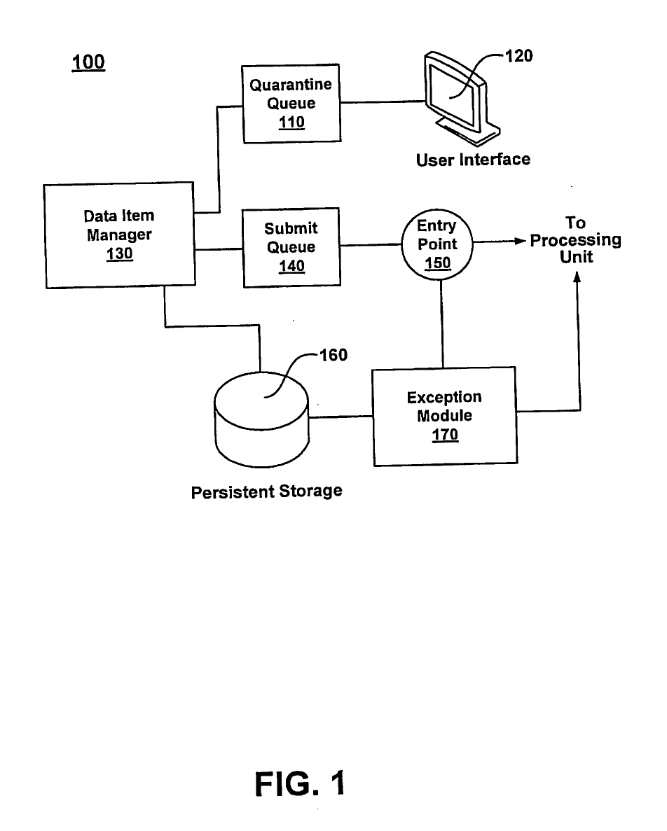

FIG. 1 is a block diagram illustrating a system 100 for detecting a data item that causes a process running on a computer system to crash, in accordance with an embodiment. The data item may be any kind of event that may be uniquely identified by the system. For example, in one embodiment, the data item is an electronic mail message. Furthermore, system 100 may work in conjunction with any system that runs any operations on multiple data items. For example, system 100 may work in conjunction with an electronic mail server, a database, or the like.

System 100 includes submit queue 140, which is a queue of data items waiting to be processed. The data items must pass through an entry point 150 before being passed into the processing unit (not shown). Entry point 150 determines a unique identifier for each data item and temporarily stores the unique identifier prior to the data item being processed. The unique identifier may be a property on the data item or it may be computed based on certain properties of the data item which do not change every time the data item is processed. For example, the unique identifier may be a filename, a database ID, etc., so long as it is unique to the data item. In one embodiment, entry point 150 is a thread and the unique identifier is stored in a thread local storage, which is alive until the thread has finished processing the data item. If the processing of the data item causes the process running on the computer system to crash (e.g., due to a vulnerability in the software code), exception module 170 is invoked. In one embodiment, exception module 170 is an Unhandled Exception Handler. In another embodiment, exception module 170 is an exception filter. Exception module 170 performs certain brief operations prior to the process running on the computer system restarting. In one embodiment for example, exception module 170 causes the unique identifier to be stored in a persistent storage 160. In one embodiment, the exception module reads the thread local storage (i.e., unique identifier on the crashing thread) to identify which data item was currently being processed when the system crashed. The persistent storage may be any type of storage that is preserved when the process running on the computer system crashes and a restarts, such as a file, a registry key, or the like.

System 100 also includes data item manager 130. Once the process running on the computer system has restarted, data item manager 130 reads the unique identifier from the persistent storage 160 and flags the data item associated with the unique identifier as a poison data item. At this point, data item manager 130 may isolate the poison data item from normal processing.

In one embodiment, system 100 also stores a crash count for each data item in a persistent storage. The persistent storage in which the crash count is stored may be the same persistent storage in which the unique identifier is stored (i.e., persistent storage 260) or it may be separate. The crash counts are initially set to zero. Upon restarting, data item manager 130 increments the crash count for the data item flagged as the poison data item. At this point, the unique identifier can be deleted from first persistent storage 160 as the crash count has been updated and the data item has been flagged. In one embodiment, the data item manager checks the crash count for the poison data item against a crash threshold value. The crash threshold value may be defined in a number of ways, such as pre-defined in software, user-defined, etc. The crash threshold value sets the number of times a crash may occur while processing a particular data item before that data item is removed from normal processing operations. Thus, if the crash count for the poison data item is less than the crash threshold value, data item manager 130 submits the poison data item to be processed again. If the crash count is equal to or greater than the crash threshold value, data item manager 130 isolates the poison data item into quarantine queue 110, which may contain other poison data items.

In one embodiment, system 100 also includes a user-interface for analyzing and manipulating poison data items. In an exemplary embodiment, the user may take various actions on the quarantine queue, such as viewing the data items in the queue, importing the data items to a file to send to the software developer for further diagnosis of the problem, deleting the data item from the system completely, re-inserting the data item into the normal processing queue, etc.

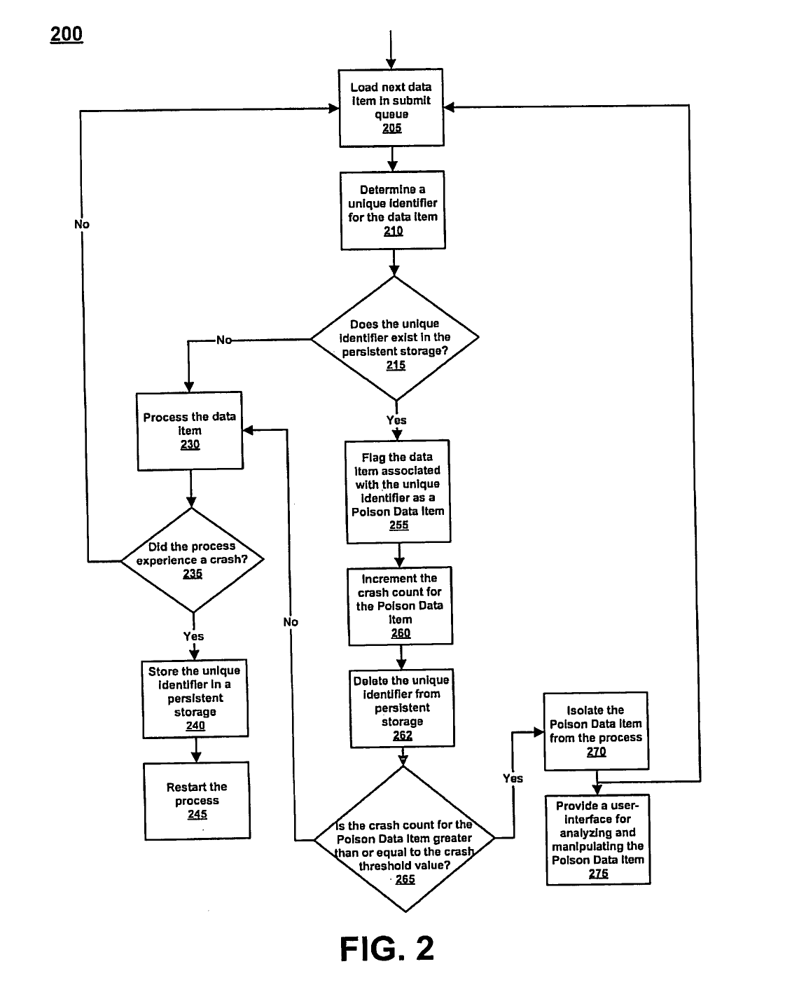

FIG. 2 is a flowchart illustrating a process 200 of detecting a data item that causes a process running on a computer system to crash when processed, in accordance with an embodiment of the present invention. Steps of process 200 may be stored as instructions on a computer readable medium and executed on a computer processor. The data item may be any kind of event that may be uniquely identified by the system. For example, in one embodiment, the data item is an electronic mail message. Furthermore, process 200 may be implemented on any system that runs any operations on multiple data items. For example, process 200 may be implemented on an electronic mail server, a database, or the like.

Step 205 involves loading the next data item, which is typically loaded from a queue of multiple data items. This may commonly involve initializing a new processing thread for the current data item. At step 210, a unique identifier is determined for the data item. The unique identifier may be a property on the data item or it may be computed based on certain properties of the data item which do not change every time the data item is processed. For example, the unique identifier may be a filename, a database ID, etc., so long as it is unique to the data item. In the case where a thread has been created for the data item, the unique identifier will ordinarily be stored until the thread is done processing the data item. It should be appreciated that multiple threads may be running at the same time, with each thread processing a data item.

At step 215, a determination is made as to whether the unique identifier for the current data item exists in the persistent storage. The presence of the unique identifier in the persistent storage signifies that the current data item should be flagged as a poison item, and process will accordingly proceed to step 255 (discussed below). If the unique identifier does not exist in the persistent storage, process 200 next proceeds to step 230, where the data item is processed. At step 235, if the processing of the current data item was successful, process 200 returns to step 205, where the next data item is loaded for processing. If, however, the processing of the data item caused the process running on the computer system to crash (e.g., due to a vulnerability in the software code), process 200 proceeds to step 240, where the data item's unique identifier is stored in a persistent storage. The persistent storage may be any type of storage that is preserved when the process running on the computer system crashes and a restarts, such as a file, a registry key, or the like. In the following examples, this step will be described as being handled by an Unhandled Exception Handler, which is invoked whenever an exception is thrown which is not handled. However, it will be appreciated that this step may be handled by any other process or module that is invoked when the process running on the computer system is crashing or has crashed. The Unhandled Exception Handler may read the thread local storage (i.e., unique identifier on the crashing thread) to identify which data item was currently being processed when the process crashed.

At step 245, the process running on the computer system is restarted. Once the process has restarted, process 200 resumes at step 205, where the process again loads the next data item in the submit queue.

As stated above, if it is determined at step 215 that the unique identifier for the current data item exists in the persistent storage, process 200 proceeds to step 255, and the data item associated with the unique identifier is flagged as a poison data item.

At step 260, a crash count for the poison data item is incremented. It should be appreciated that although step 260 in FIG. 2 occurs after restarting, it may also occur prior to restarting. In one embodiment, the crash count is stored in the first persistent storage.

At step 265, the crash count for the Poison Data item is checked against a crash threshold value. The crash threshold value sets the number of times a crash may occur while processing a particular data item before that data item is removed from normal processing operations. The crash threshold value may be defined in a number of ways. For example, the crash threshold value may be pre-defined in software code, it may be user-defined, etc. The purpose of the crash threshold value is to hedge against the possibility that the crash was not due to the processing of the data item flagged as the poison data item. The higher the crash threshold value, the higher the probability that the data item being processed is the reason for the crashes. The lower the crash threshold value, the quicker the offending data item is handled. Thus, at step 265, if the crash count for the poison data item is less than the crash threshold value, process 200 returns to step 230 where the poison data item is re-submitted for processing. If the crash count is equal to or greater than the crash threshold value, process 200 proceeds to step 270, where the poison data item is isolated from the process. This may involve placing the poison data item into a separate quarantine queue of other poison data items. In one embodiment, process 200 also includes expiring an entry from the persistent storage after a certain amount of time (step not shown).

At step 275, a user-interface is provided for analyzing and manipulating the poison data item. In an exemplary embodiment, the user may take various actions on the quarantine queue, such as viewing the data items in the queue, importing the data items to a file to send to the software developer for further diagnosis of the problem, deleting the data item from the system completely, re-inserting the data item into the normal processing queue, etc.

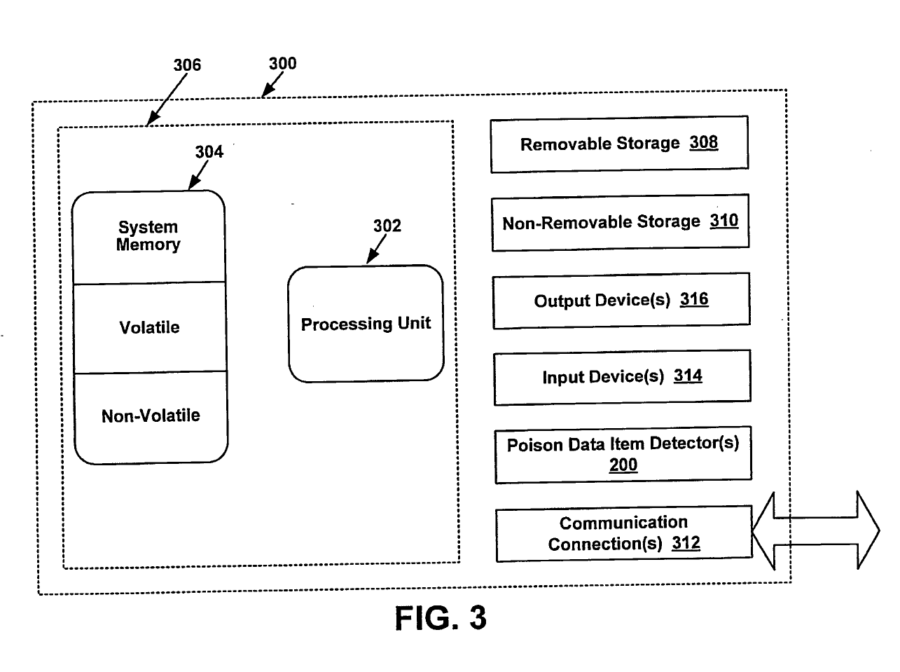

FIG. 3 illustrates an example of a suitable computer system 300 on which embodiments may be implemented. The computer system 300 is only one example of a suitable computing environment and is not intended to suggest any limitation as to the scope or functionality of the invention. Neither should be computer system 300 be interpreted as having any dependency or requirement relating to any one or combination of components illustrated in the exemplary computer system 300.

With reference to FIG. 3, an exemplary system for implementing embodiments includes a general purpose computer system, such as computer system 300. In its most basic configuration, computer system 300 typically includes at least one processing unit 302 and memory 304. Depending on the exact configuration and type of computing device, memory 304 may be volatile (such as RAM), non-volatile (such as ROM, flash memory, etc.) or some combination of the two. This most basic configuration is illustrated in FIG. 3 by dashed line 306. Computer system 300 also includes Poison Data Item Detector 200, which is shown in detail in FIG. 2 and described in detail above. Additionally, computer system 300 may also have additional features/functionality. For example, computer system 300 may also include additional storage (removable and/or non-removable) including, but not limited to, magnetic or optical disks or tape. Such additional storage is illustrated in FIG. 3 by removable storage 308 and non-removable storage 310. Computer storage media includes volatile and nonvolatile, removable and non-removable media implemented in any method or technology for storage of information such as computer readable instructions, data structures, program modules or other data. Memory 304, removable storage 308 and nonremovable storage 310 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computer system 300. Any such computer storage media may be part of computer system 300.

Computer system 300 may also contain communications connection(s) 312 that allow the device to communicate with other devices. Communications connection(s) 312 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media. Computer system 300 may also have input device(s) 314 such as a keyboard, mouse, pen, voice input device, touch input device, etc. Output device(s) 316 such as a display, speakers, printer, etc. may also be included. All these devices are well known in the art and need not be discussed at length here.

Thus, embodiments of the present invention provide means for detecting a data item that causes a process running on a computer system to crash. Once the offending data item has been detected, embodiments provide means for isolating the data item and thereby preventing a continuous crash-restart loop. Furthermore, the isolation means may be user-configurable to conform to the user's needs. Embodiments thus alleviate the sometimes expensive and tedious need for manual examination of the system to determine the cause of the crash.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of detecting a data item that causes a process running on a computer system to crash when processed, wherein the process running on the computer system processes multiple data items, the method comprising:
associating unique identifiers with data items prior to the data items being processed;
provided the processing of a particular data item causes a crash, storing the unique identifier corresponding to the particular data item in a persistent storage;
restarting the process in response to the crash;
reading the unique identifier from the persistent storage; and
flagging the particular data item associated with the unique identifier as causing the process to crash.

2. The method as recited in claim 1 further comprising:
storing a crash count for each data item, wherein the crash count is initially set to zero; and
incrementing the crash count for the particular data item.

3. The method as recited in claim 2 wherein the crash count is stored in the persistent storage and the method further comprises:
expiring an entry from the persistent storage after the entry has been stored in the persistent storage for a period of time.

4. The method as recited in claim 2 further comprising:
provided the crash count is equal to or greater than a threshold value, isolating the particular data item that caused the process to crash; and
provided the crash count is less than the threshold value, submitting the particular data item that caused the process to crash to be processed again.

5. The method as recited in claim 4 wherein the threshold value is user-definable.

6. The method as recited in claim 1 wherein the method is implemented in an electronic mail server.

7. The method as recited in claim 1 wherein the method is implemented in a database.

8. A system for detecting a data item that causes a process running on a computer system to crash when processed, wherein the process running on the computer system processes multiple data items, the system comprising:
a processor having an entry point that associates and temporarily stores a unique identifier with data items prior to the data item being processed;
at least one persistent storage for storing data;
an exception module which is invoked whenever the processing of a particular data item causes a crash, wherein the exception module causes the unique identifier associated with the particular data item to be stored in the at least one persistent storage;
a data item manager that, upon the process restarting, reads the unique identifier corresponding to the particular data item from the at least one persistent storage and flags the particular data item associated with the unique identifier as causing the process to crash.

9. The system as recited in claim 8 wherein the at least one persistent storage is also for storing a crash count for each data item, wherein the crash count is initially set to zero.

10. The system as recited in claim 9 wherein the data item manager, upon the process restarting, increments the crash count for the particular data item that caused the process to crash.

11. The system as recited in claim 10 wherein the data item manager isolates the particular data item that caused the process to crash if the crash count is equal to or greater than a threshold value and submits the particular data item that caused the process to crash to be processed again if the crash count is less than the threshold value.

12. The system as recited in claim 11 wherein the threshold value is user-definable.

13. The system as recited in claim 8 further comprising:
a user-interface for analyzing and manipulating the particular data item that caused the process to crash.

14. The system as recited in claim 8 wherein the at least one persistent storage is a file.

15. The system as recited in claim 8 wherein the at least one persistent storage is a registry key.

16. A computer-usable medium having computer-readable program code stored thereon for causing a computer system to execute a method for detecting a data item that causes a process running on a computer system to crash when processed, wherein the process running on the computer system processes multiple data items, the method comprising the steps of:
(a) loading a current data item from a queue of a plurality of data items;
(b) determining a unique identifier for the current data item;
(c) determining if the unique identifier exists in a persistent storage on the computer system;
(d) if the unique identifier does exist in the persistent storage:
i. flagging the current data item as a poison data item; and
(e) if the unique identifier does not exist in the persistent storage:
i. processing the current data item; and
ii. if a crash occurs while processing the current data item:
(1) storing the unique identifier in the persistent storage; and
(2) restarting the process.

17. The computer-usable medium as recited in claim 16 wherein step (d) further comprises the step of:
ii. isolating the current data item.

18. The computer-usable medium as recited in claim 16 wherein step (d) further comprises the step of:
iii. providing a user-interface for analyzing and manipulating the current data item.

19. The computer-usable medium as recited in claim 16 wherein the persistent storage is a file.

20. The computer-usable medium as recited in claim 16 wherein the persistent storage is a registry key.
